(19) United States
(12) Patent Application Publication
(10) Pub. No.: US 2022/0316719 A1
(43) Pub. Date: Oct. 6, 2022

(54) COMPRESSOR WALL

(71) Applicant: Dehumidified Air Solutions, Inc., Quebec (CA)

(72) Inventor: Jonathan THERIAULT, Quebec (CA)

(21) Appl. No.: 16/647,439

(22) PCT Filed: Dec. 10, 2019
(86) PCT No.: PCT/IB2019/060635

§ 371 Date: Mar. 13, 2020

(51) Int. Cl. F24F 1/68; F24F 1/46

(52) U.S. Cl. CPC F24F 1/68; F24F 1/46; F24F 5/0071

(57) ABSTRACT

Embodiments of the present disclosure provide an array of modularized circuits that work individually but collectively to provide a system that can manage an indoor environment. The system is designed in order to match the delivered load more closely to the required load then has been done in the past. The system is also designed in order to enhance and ease of serviceability of the individual circuits when needed.

### FIELD OF THE DISCLOSURE

Embodiments of the present disclosure relate generally to dehumidification and air conditioning systems for indoor spaces. Particular embodiments find use in indoor pool rooms and indoor agricultural grow rooms, both of which have extensive dehumidification and air conditioning needs. However, the disclosed technology may be used in connection with any other type of HVAC application. The demands of the needs in these types of rooms can vary significantly, either as a result of the different activities conducted in the room, the number of people and/or the number of plants in the room at any particular time, the time of day, the annual seasonal effect on the building, and/or various combinations thereof. This disclosure seeks to provide an efficient way to manage and scale (either up or down) dehumidification and air conditioning needs for interior spaces.

### BACKGROUND

Designing or specifying equipment for an indoor pool environment or an indoor grow house /grow room environment can present challenges. Specifically, these challenges can include properly adjusting the indoor air environment, which can be exacerbated by the fact that the equipment must be designed to handle a maximum load, which is not always the load experienced in the environment. For example, pool room dehumidification equipment must be able to dehumidify the room when an absolute maximum number of bathers is present. However, there are many instances when fewer than the maximum number of bathers will be enjoying the pool room environment.

Additionally, with indoor pool environments, there is a complex set of factors to balance. These factors include but are not limited to room size, pool activity levels, expected and actual capacity, inside air and water temperatures, air distribution, outside air temperatures and humidity ranges, proper building features, HVAC and humidity control design, operating and maintenance costs, along with a number of other factors, as well as ultimately, the need to meet patron expectations. These factors may all be interrelated on various levels. Similarly, with indoor grow room environments, various factors that can present challenges include but are not limited to a desire for the environment to house a varied number of plants and/or varied types of plants, which may all exhibit various differences in carbon dioxide consumption, oxygen offload, and perspiration; necessary light levels; time of day; desired humidification level; and/or desired temperature level. The above-described pool environment factors may also be present. Getting any one of these factors wrong in the environment can lead to problems, and potentially expensive and/or frustrating results for the indoor environment owners, operators, and patrons.

As discussed above, current equipment for these environments must be designed to manage a maximum capacity, whether a maximum bather capacity, a maximum plant capacity, or other expectations. However, maximum capacity may not always be reached. For example, an indoor pool may be designed with equipment that is required to manage an environment for a capacity of 50-60 people. In the instance when only two or three people are in the pool room, the equipment must still typically operate at the same or similar levels required for maximum capacity. This can result in wasted energy. The same example may be envisioned for an indoor grow room environment. If the indoor grow room environment is designed with equipment that is required to manage plants within a certain square footage, but only half of the environment is filled with plants, the equipment must still typically operate at the same or similar levels required for maximum capacity. This can also result in wasted energy.

Additionally, at nighttime, plants expel large amounts of moisture which increases the level of humidity in the grow room. This excess moisture needs to be kept under control in order to allow the plants to thrive. The disclosed technology is designed to incrementally increase the dehumidification capacity to match the load required at any given point. Furthermore, in the daytime, the grow room may require a significant reduction in dehumidification needs and an increase in cooling needs, due to the daylight lighting load. The disclosed technology can help maintain a steady state with the appropriate capacity matching.

### BRIEF SUMMARY

Embodiments of the present disclosure provide a system that fragments unit cooling in dehumidification capacity into incremental sizes. The general goal is that only the appropriate amount of capacity is in use for systems at any given need. This can provide better room control and can reduce the amount of capacity cycling typically required by systems that only incorporate one or two large, many ton compressors.

Specifically, in one example, there is provided an air management system, comprising: a plurality of circuits, each circuit comprising an evaporator, a compressor, and a plate heat exchanger; wherein each circuit in the plurality of circuits is configured to be operated independently of the other circuits, wherein the plurality of circuits are provided in a modular array. Each circuit may be mounted within a module housing. The module housings may be mounted within a master housing. The plurality of circuits may be fluidly connected via a hydronic loop. The circuits may receive airflow and may be configured to cool or warm the received airflow and expel cooled or warmed air into an indoor environment. In one example, the system is mounted with respect to an indoor pool. In an alternate example, the system is mounted with respect to an indoor growing room or greenhouse. In other examples, the system may be used in connection with any other type of HVAC application. These include but are not limited to air-conditioning and dedicated outdoor air systems (DOAS).

It is generally desirable that each circuit within the plurality of circuits is configured to be separately removable from the system, and the system is configured to continue to function with one or more circuits removed from the system.

The system may include one or more fluid pumps, one or more check valves, one or more modulating valves, one or more filters, or any combination thereof. These may be shared features, that function to flow the fluid through the hydronic loop. It is possible for each circuit in the plurality of circuits to range in size anywhere from about 2 to about 40 tons.

Another example provides a method for maintaining an indoor environment, comprising: providing an air management system as described herein; removing at least one of the circuits from the plurality of circuits from the system for repair or replacement; and continuing to run the air management system without the removed circuit.

A further example provides a method for maintaining an indoor environment, comprising: providing an air management system of claim 1, wherein the air management system is configured to receive and react to information about load capacity; and activating only a number of circuits within the plurality of circuits necessary to maintain the load capacity.

### BRIEF DESCRIPTION OF THE DRAWINGS

FIG. 1 shows a schematic view of one embodiment of the disclosure.

FIG. 2A shows a side perspective view of a single circuit that may be used in connection with this disclosure.

FIG. 2B shows the single circuit of FIG. 2A without the housing in place.

FIG. 3 shows a front plan view of a plurality of circuits and a master housing.

FIG. 4 shows a front plan view of FIG. 3 with additional conduits to complete the hydronic loop.

FIG. 5 shows a top perspective view of one embodiment of a compressor wall disclosed herein.

FIG. 6A shows a side plan view of FIG. 5.

FIG. 6B shows a side schematic view of FIG. 5.

FIG. 7 shows a top plan view of FIG. 5.

### DETAILED DESCRIPTION

Matching the unit capacity to the load in the desired space is often not well executed due to current limitations of equipment. For example, it is often the case that one or more 20 or 30 ton circuits are installed for indoor environment management. However, if a load only requires 2 tons, a 20 or a 30 ton circuit must still be run.

Embodiments of the present disclosure thus provide a compressor wall system 10 that incorporates a plurality or series of smaller circuits 12 to achieve the required capacity modulation. Generally, providing a series of smaller circuits 12 can better match a given load in real time as opposed to a single larger circuit or multiple larger circuits. This allows the system to achieve a required capacity modulation by only activating the number of circuits required to reach the amount of capacity for the current need.

In a specific example, four to sixteen smaller circuits 12 may comprise the system 10. These smaller circuit 12 may be from about 3-12 tons. In specific examples, the compressors may be 6-8 ton compressors. Specific tests have been run with 6.33 ton and 7.8 ton compressors with good results. It should be understood that each circuit is capable of operating independently from every other circuit. The circuits operate on their own, but may be mounted in a module such that they provide an array of independently operating circuits. If a single circuit is removed, it does not affect the operation of the remaining circuits.

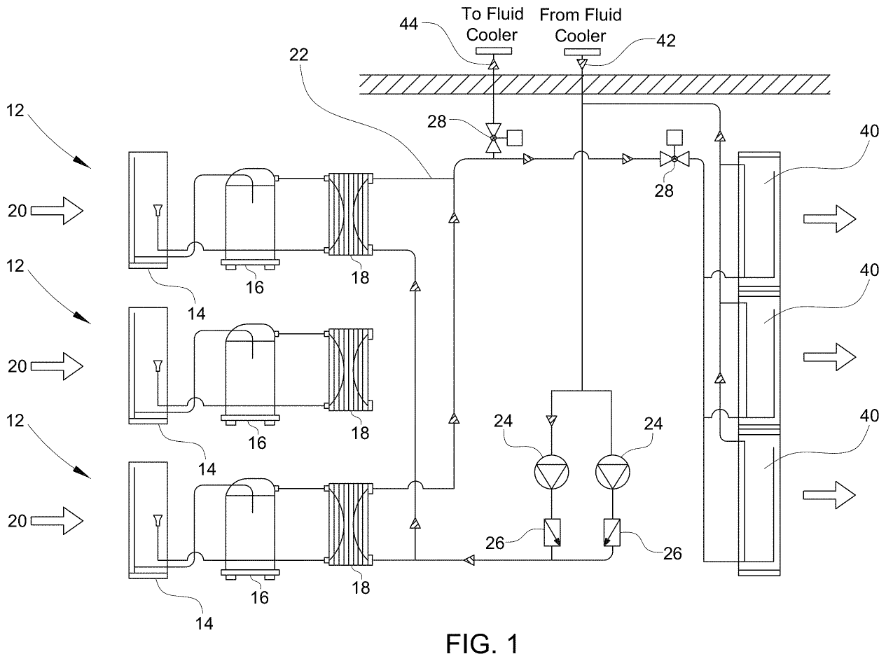

FIG. 1 illustrates an exemplary piping schematic illustrating the use of three smaller circuits 12. Although three circuits 12 are illustrated in the schematic, it should be understood that more circuits may be added in parallel to provide a larger matrix of circuits, as described further below. The system is designed to be scalable up or down dependent upon load. As shown, each smaller circuit 12 incorporates an evaporator 14, a compressor 16, and a plate heat exchanger 18. As general background, in use, air flows across the evaporator 14 as illustrated by airflow arrow 20. Evaporator coils in the evaporator 14 function to absorb (or remove) heat from the air. The compressor 16 circulates refrigerant necessary for heat exchange and applies energy to the refrigerant. The constant flow of refrigerant results in constant heat transferring. The compressor 16 raises the temperature and pressure of the vapor refrigerant that leaves the evaporator 14. After the condenser 16, the refrigerant typically flows through an expansion valve, where it experiences a pressure drop. Finally, as refrigerant flows through the heat exchanger 18, it condenses from vapor form to liquid form, giving off heat in the process. The evaporator 14 can draw heat from the region that is to be cooled. The vaporized refrigerant returns to the compressor 16 to restart the cycle. Heat may be rejected external to the system (outside) or if heat is needed within the environment, it can be delivered back inside to the environment. This transfer may be referred to herein as a hydronic loop 22.

As shown by the hydronic loop 22 of FIG. 1, the series of circuits 12 may share one or more fluid pumps 24 and/or one or more check valves 26. The fluid pumps 24 function to move a fluid mixture comprised of water and glycol throughout the hydronic loop 22. The check valves 26 function to prevent backflow or reverse flow into the fluid pumps 24. The circuits 12 may also share one or more modulating valves 28. The modulating valves 28 function to control the amount of flow and/or flow rate through the hydronic loop 22. Although the circuits share various valves and pumps in common with the hydronic loop 22, it should be understood that each individual circuit is provided with the components required to operate the circuit, such that it operates independently from the other circuits. FIG. 1 also illustrates hydronic reheat coils 40. The heat being rejected in each brazed plate heat exchanger 18 can then be circulated into a hydronic reheat coil 40 or to the outdoor fluid cooler via modulating valve 28.

Airflow and coolant flow through the system as follows. Coolant fluid from a fluid cooler enters the system at inlet 42, flowing through a conduit and moved via one or more fluid pumps 24. The fluid is directed past and through a heat exchanger 18. Airflow 20 also enters the system across evaporators 14. Heat from airflow is transferred to the refrigerant or coolant fluid, which cools the air and warms the coolant fluid. The warmed coolant fluid is then delivered to a fluid cooler via an outlet 44. The cooled air passes over one or more hydronic reheat coils 40 and is delivered to the environment. If warmed air is needed in the environment, rather than exhausting warmed air external to the system, it may be routed across the hydronic reheat coils 40 and delivered to the environment.

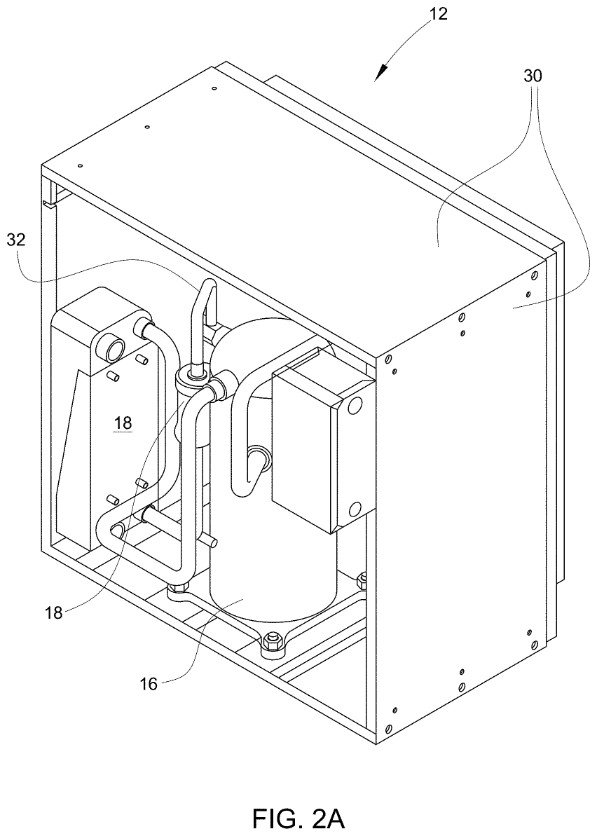

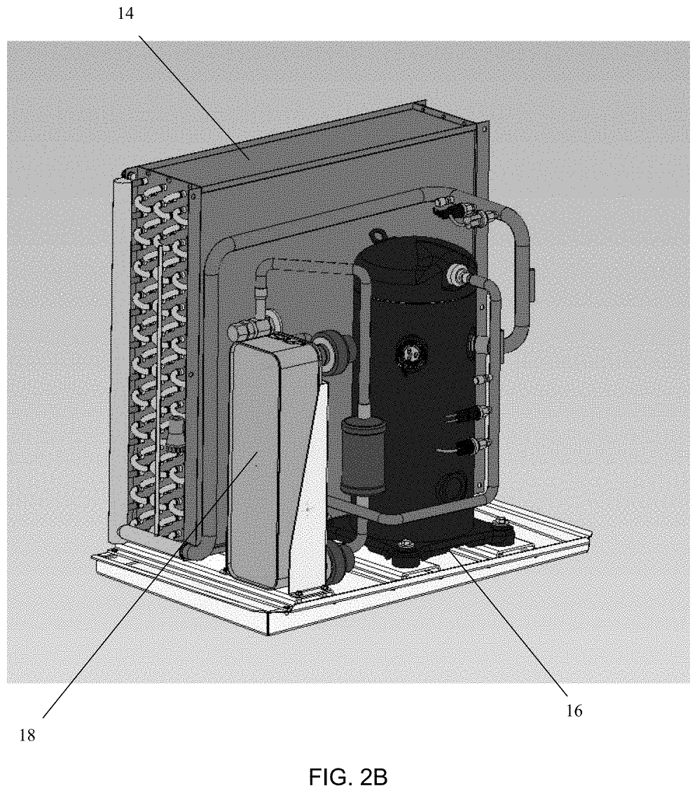

FIGS. 2A and 2B illustrate an example of a single circuit 12 contained within a module housing 30. This circuit 12 incorporates an evaporator 14, a compressor 16, and a plate heat exchanger 18, as well as accompanying conduits 32 that are configured to manage flow therebetween.

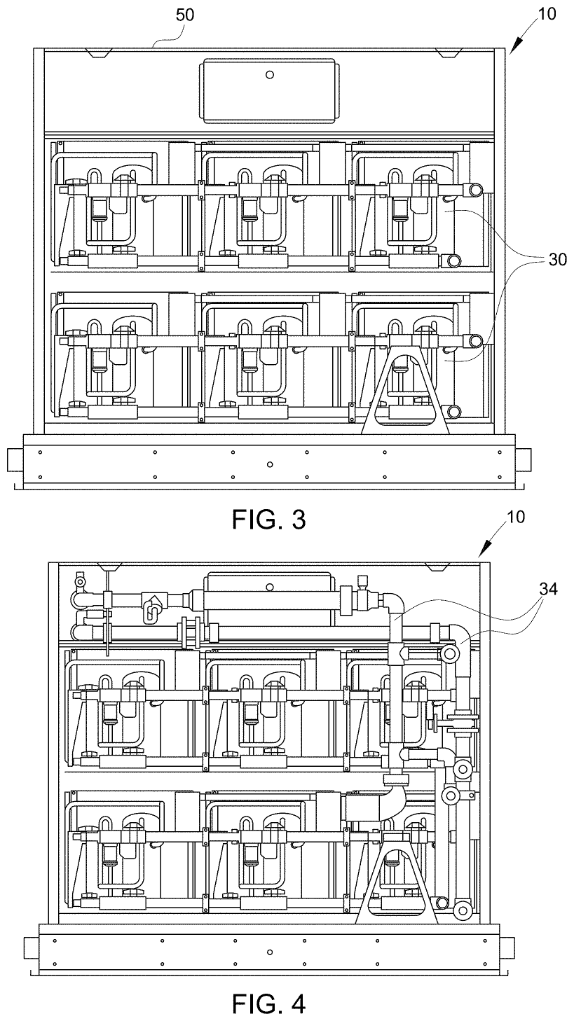

FIG. 3 illustrates a front plan view of a plurality of module housings 30 mounted within a single system 10. This example shows a 3×2 embodiment, with three module housings 30 in two rows, for a total of six module housings 30 forming the system. It should be understood that the system configuration may instead be 2×3, 2×2, 3×3, 4×2, 2×4, 4×3, 3×4, 4×4, 5×2, 2×5, 5×3, 3×5, 5×4, 4×5, 5×5, 6×2, 2×6, 6×3, 3×6, 6×4, 4×6, 6×5, 6×5, 6×6, 7×2, 2×7, 7×3, 3×7, 7×4, 4×7, 7×5, 5×7, 6×7, 7×6, 7×7, 8×2, 2×8, 8×3, 3×8, 8×4, 4×8, 8×5, 5×8, 8×6, 6×8, 8×7, 7×8, 8×8, and so forth up to any appropriate combination of module housings 30. These examples are provided for illustration only and are not intended to be limiting of the disclosure in any way. FIG. 4 illustrates the configuration of FIG. 3 with added connection tubing 34, which connects each module housing 30 to the hydronic loop 22 as a whole.

One of the benefits of the disclosed system 10 is that by providing an array of circuits 12 contained in individual module housings 30 within a single system 10, it is easy to interchange or otherwise replace one of the circuits 12 when needed. For example, in a 4×4 array that has sixteen circuits 12, if a single circuit 12 malfunctions, it may be replaced or repaired without affecting the remainder of the circuits or their functioning. Additionally, until that single circuit can be replaced or repaired, the entire system 10 can continue to run at almost capacity. In this example, fifteen circuits are still available.

An additional benefit of the disclosed system 10 is that it is possible to maintain a load at any given point by turning on or off any of the circuits 12 in the system 10. As an example, a traditional system may have two 30-ton circuits managing a particular environment. It may be the case that a particular load only requires 15 tons at a particular level of capacity. However, even if only one circuit is turned on in this example, 30 tons are in use, meaning that extra energy is expended/wasted. By contrast, if a system incorporates twelve 6-ton circuits managing a particular environment and only 15 tons is required, it is possible to only activate three circuits to deliver 18 tons, resulting in a great energy saving. In the example provided, it is possible to manage a load as low as 6 tons with only a single circuit. This allows the system to easily match the load in real time by managing activation of only the number of circuits required although a complete load is always available when/if needed. A greater number of circuits and smaller circuits may also be used.

As shown by FIGS. 3 and 4, the system 10 may include a master housing 50 that houses or otherwise encloses the individual module housings 30, each of which supports an individual circuit 12. For removal or replacement, it is possible to provide the module housings 30 on slidable trays that can slide in and out of the master housing 50 on a track, much like drawers. When the user pulls a drawer forward, a lifting device may be used in order to remove the circuit. Additionally or alternatively, it is possible to provide a back or front or side wall that can slide open, allowing front, back, and/or side access to the module housings 30.

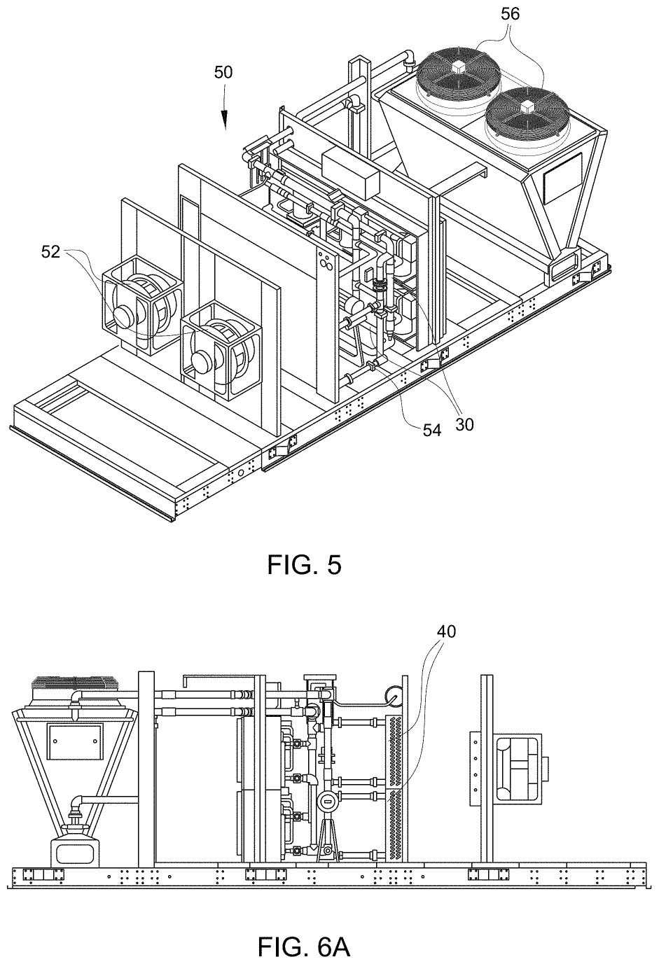

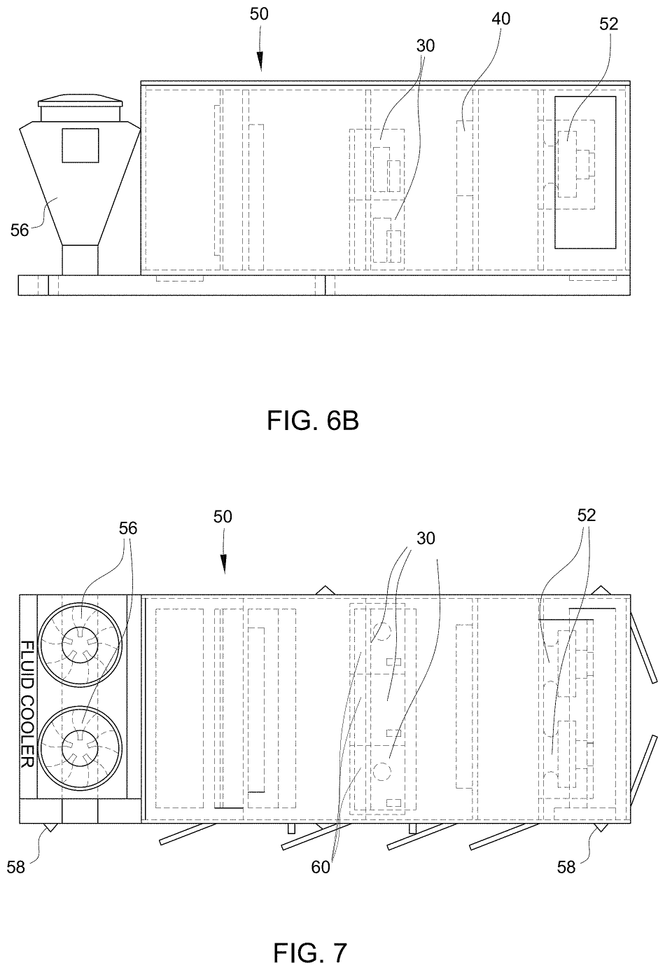

FIG. 5 shows a side perspective view of an exemplary master housing 50 that supports one or more blowers/air movers, a rack 54 supporting a plurality of module housings 30, and air expelling units 56. FIG. 6A shows a side plan view of the same configuration, and FIG. 6B shows the same configuration schematically. FIG. 7 shows a top plan view of the same configuration. As shown in these figures, one or more lifting lugs 58 may be provided that can be used to lift the equipment during installation. FIG. 7 also shows filters 60. The filters 40 function to ensure that the air delivered to the environment is filtered and free of allergens, dust, or other debris that may accumulate in the system.

In a specific example, the circuits 12 may be individual water-cooled air conditioning modules that can easily be replaced if one module experiences difficulty. The individual modules may all be connected to a single fluid cooled loop (hydronic loop 22) that is cooled by fluid coils. The fluid coils may either be located in the air handling unit for reheat purposes or may be located outdoors for rejection of heat to the outdoors. This may be configured to be switched in use as well. For example, if heat is needed inside the environment, heat may be routed inside. If the inside environment needs to be cooled, the heat may be routed outside the environment. A valve, dial, or other modulator may be provided in order to actuate this movement of warmed air.

It is possible to vary or alter the number of modules or the size of each of the module components. It is also possible to vary the location of the components. In summary, there is provided an array of modularized circuits that work collectively to provide a system that can manage an indoor environment. The system is designed in order to match the delivered load more closely to the required load then has been done in the past. The system is also designed in order to enhance and ease of serviceability of the individual circuits when needed.

Advantages of the disclosed system include but are not limited to enhanced capacity control; ease of serviceability; a more compact air handling unit; redundancy in compressor capacity at partial loads; improved energy efficiency at partial loads; decrease in manufacturing labor.

The traditional and prevailing thought had been that it is more costly to build a system using a greater number of smaller circuits than it is to provide the traditional larger circuit configuration with fewer circuits. The present inventors have broken that paradigm by designing the disclosed system.

The subject matter of certain embodiments of this disclosure is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

It should be understood that different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Changes and modifications, additions and deletions may be made to the structures and methods recited above and shown in the drawings without departing from the scope or spirit of the invention disclosure and the following claims.

What is claimed is:

1. An air management system, comprising:
a plurality of circuits, each circuit comprising an evaporator, a compressor, and a plate heat exchanger;
wherein each circuit in the plurality of circuits is configured to operate independently of the other circuits,
wherein the plurality of circuits are provided in a modular array.

2. The system of claim 1, wherein each circuit is mounted within a module housing, and wherein the module housings are mounted within a master housing.

3. The system of claim 1, wherein the plurality of circuits are fluidly connected via a hydronic loop.

4. The system of claim 1, wherein the circuits receive airflow and are configured to cool or warm the received airflow and expel cooled or warmed air into an indoor environment.

5. The system of claim 1, mounted with respect to an indoor pool.

6. The system of claim 1, mounted with respect to an indoor growing room or greenhouse.

7. The system of claim 1, used in connection with an HVAC system, and air conditioning system, or a dedicated outdoor air system (DOAS).

8. The system of claim 1, wherein each circuit within the plurality of circuits is configured to be separately removable from the system, and wherein the system is configured to continue to function with one or more circuits removed from the system.

9. The system of claim 1, further comprising one or more fluid pumps, one or more check valves, one or more modulating valves, one or more filters, or any combination thereof.

10. The system of claim 1, wherein each circuit in the plurality of circuits ranges from about 2 to about 40 tons.

11. A method for maintaining an indoor environment, comprising:
providing an air management system of claim 1;
removing at least one of the circuits from the plurality of circuits from the system for repair or replacement; and
continuing to run the air management system without the removed circuit.

12. A method for maintaining an indoor environment, comprising:
providing an air management system of claim 1, wherein the air management system is configured to receive and react to information about load capacity;
activating only a number of circuits within the plurality of circuits necessary to maintain the load capacity.
